(19) United States
(12) Patent Application Publication
(10) Pub. No.: US 2002/0179229 A1
(43) Pub. Date: Dec. 5, 2002

(54) Corrugator double backer with combined driven and static holddown sections

(76) Inventor: Matthew J. Chuzles, Phillips, WI (US)

Correspondence Address: ANDRUS, SCEALES, STARKE & SAWALL, LLP, 100 EAST WISCONSIN AVENUE, SUITE 1100, MILWAUKEE, WI, 53202, US

(21) Appl. No.: 09/871,164

(22) Filed: May 31, 2001

(51) Int. Cl. B31F 1/00

(52) U.S. Cl. 156/205; 156/199; 156/210; 156/443

(57) ABSTRACT

A hybrid double backer for the formation of a double face corrugated paperboard web combines an upstream driven holddown belt section and a downstream static porous mesh belt holddown section that provides optimum curing and drying of the paperboard web.

### BACKGROUND OF THE INVENTION

The present invention pertains to the formation of a double face corrugated paperboard web under the application of heat and pressure and, more particularly, to a hybrid double backer construction utilizing a combination of a driven holddown belt and a stationary porous holddown belt.

Double backer apparatus for the production of double face corrugated paperboard has been well developed in the art. The use of starch-based adhesives to form the glue lines on the corrugated medium flute tips to which a liner web is applied requires the application of heat and pressure. Typically, a single face corrugated web, comprising a corrugated medium to which a single liner web has been glued, is formed upstream of the double backer in one of several types of single facer machines. The exposed flute tips on the single face web are then coated with glue lines and brought into contact with a second liner web just prior to entry into the double backer.

In virtually all double backers in use today, the freshly glued double face web is moved over a hot plate section with the newly applied liner web lying against the hot plates. The entire heated surface of the double backer may be 40 feet (about 12 m) in length and be comprised of 20 individually heated hot plates mounted in abutting relation. All prior art double backers also include some means for applying a load to the upper surface of the double face web to enhance the heat exchanging contact between the hot plates and the web. As the web is moved through the heating section, between the hot plates and some type of overlying holddown means, the starch adhesive is first gelatinized and then moves into the so-called “green bond stage” where the glue lines cure and gain strength by dehydration. As the web moves further toward the downstream outfeed end, the heat from the hot plates drives moisture from the web and causes it to dry.

For many years, double backers have been constructed with a driven holddown belt extending over the entire heating section and positioned in contact with the double face web, so that the holddown belt performs the dual function of holding the freshly glued web in intimate contact with the hot plates and moving the web through the heating section by direct frictional contact with the web. In addition, the horizontal run of the holddown belt in contact with the web is typically provided with a supplemental ballast load to enhance the engagement of the web by the belt. Many variations of ballast loading devices have been used, including ballast rollers, air pressure nozzles, inflatable bladders, and pressure plates. Means to vary the magnitude of the ballast load applied over the length of the heating section have been used with all of the various ballast load devices.

However, holddown belts that extend the full length of the heating section of a double backer are cumbersome to operate and to maintain and in addition, as the speed of corrugator lines has increased, it has been found difficult to adjust the speed through the double backer to accommodate higher line speeds and yet assure that the double face web exiting the double backer is thoroughly dried. For example, the impervious holddown belt has been found to inhibit the passage of steam and moisture from the web as it dries, particularly in the downstream section of the double backer. As a result, double face web exiting the double backer that is not sufficiently dried, may not be suitably conditioned for the cutting and slitting operations that follow immediately in the dry end of the corrugator.

More recently, attempts have been made to eliminate the driven holddown belt with static holddown devices that lie atop the single face web which web must then be pulled through the double backer by a downstream web drive means, such as a pair of drive belts between which the web travels or a vacuum conveyor device. Such static holddown devices have provided some significant benefits in controlling web drying. One such device comprises a flexible holddown mat, the length of which in contact with the moving double face web is controlled by a downstream lift device that allows more or less of the length of the holddown mat to be maintained in contact with the web. Other static holddown devices, such as plates, rollers, and inflatable bladders have also been used with varying degrees of success. One problem common to most of such static holddown devices that are placed in direct contact with the web is damage to the freshly glued web, particularly at the upstream infeed of the double backer. In particular, rupture of the moist and relatively weak double face web, particularly when running lighter weight papers, has become a serious problem. Web rupture may be caused either by friction or blowouts from poorly vented steam. In addition, so-called beltless double backers do not provide the initial heat retention at the upstream end of the double backer that facilitates rapid green bond formation in the fresh glue lines.

Thus, the more recently developed beltless double backers, though having solved some of the problems associated with the prior use of driven holddown belts, have resulted in the creation of new problems that have not been satisfactorily addressed and resolved.

### SUMMARY OF THE INVENTION

In accordance with the present invention, a hybrid double backer utilizes the best features of a driven holddown belt and a porous static holddown device to provide optimum curing and drying of the double face web while significantly reducing tear outs and other web damage.

A double backer in accordance with the present invention utilizes a conventional heating section that includes a plurality of hot plates defining a generally horizontal and substantially continuous heated surface to support and heat the freshly glued web. A driven holddown belt section overlies an upstream portion of the heated surface beginning at the web infeed end of the double backer. The holddown belt section presses the freshly glued web against the heated surface and assists in moving the web over the surface. A horizontally stationary and vertically flexible porous belt section overlies the web along the remaining portion of the heated surface downstream from the driven belt section. The porous belt section maintains the web in contact with the heated surface and permits moisture to escape from the web. The porous belt section is provided with a lift device on the downstream end to permit the length of the flexible belt section that is contact with the web to be selectively varied. Immediately downstream from the outfeed end of the heating section, a main driven traction section engages the web and pulls the web over the surface and through the heating section.

In the presently preferred embodiment, the holddown belt section extends over less than one-half the length of the continuous heated surface. The driven holddown belt section may have a width in the cross machine direction approximately equal to the width of the hot plates. The driven holddown belt section further comprises a continuous generally impervious flexible belt that is entrained around horizontally spaced upstream and downstream pulleys to present a lower web-engaging belt face to the web moving over the heated surface. In addition, a belt pressure device overlies a portion of the holddown belt adjacent the upstream end. The belt pressure device may comprise an inflatable air bag.

The porous belt section preferably extends over the remaining portion of the heated surface not covered by the driven holddown belt section, thereby extending over more than one-half the length of the heated surface. The porous belt section has a width comparable to the width of the driven holddown belt section and thus has a width in the cross machine direction approximately equal to the width of the hot plates. In the preferred embodiment, the porous belt section comprises a flexible mesh belt that includes a series of generally parallel holddown strips that extend over the web in the direction of web travel between upstream and downstream mat end supports. The mesh belt also preferably includes a series of generally parallel flexible tie strips that extend generally perpendicular to, overlie and interconnect the holddown strips. The mesh is constructed and arranged to apply a uniformly distributed load to the double face web as it moves under the mesh. The lift device comprises a downstream cross support that is movable in a generally vertical direction. The lift device also preferably includes an upstream cross support that is operable with the downstream cross support to lift the entire porous belt section vertically from the web.

The invention also includes a method for bonding and drying a freshly glued single face corrugated paperboard web by utilizing the steps of (1) moving the freshly glued web over a heated surface between an upstream web infeed and a downstream web outfeed end, (2) forming a green bond in the adhesive by applying a combined holddown load and traction force to the web with a driven holddown belt section that overlies the web along an upstream portion of the heated surface, (3) drying the web by pressing it against a remaining portion of the heated surface downstream from the holddown belt section by use of a flexible porous belt section, and (4) pulling the web over the heated surface with a main driven traction section downstream from the outfeed end.

The forming step preferably includes applying a supplemental downward load on the holddown belt section and the web that is moving thereunder. The drying step preferably includes adjusting the vertical distance of the downstream end of the porous belt section form the web to selectively vary the length of said porous belt section in contact with the web.

### BRIEF DESCRIPTION OF THE DRAWINGS

FIG. 1 is a side elevation view of a double backer of the present invention positioned between an upstream web delivery apparatus and a downstream web traction section.

FIG. 2 is an enlarged elevation view of a portion of FIG. 10 showing the web infeed and the upstream portion of the double backer.

FIG. 3 is a further enlarged elevation detail of FIG. 2 showing the web infeed and double backer interface.

FIG. 4 is an enlarged elevation detail of a portion of FIG. 3.

FIG. 5 is a side elevation detail of the downstream end of the double backer portion shown in FIG. 2.

FIG. 6 is an enlarged end elevation view of the upstream portion of the double backer taken on line 6-6 of FIG. 2 with portions of the holddown belt removed to show details of the belt lift system.

FIG. 7 is a top plan view of the belt lift system shown in FIG. 6, also with the holddown belt removed.

FIG. 8 is a detail taken on line 8-8 of FIG. 7.

FIG. 9 is a top plan view of the framework supporting the upstream section of the double backer with many parts eliminated to show particular details of one feature.

FIG. 10 is a top plan view of the upstream belt section of the double facer with portions of mesh ballast mat and lift devices removed.

FIG. 11 is an enlarged elevation view taken on line 10-10 of FIG. 1 with the mesh belt section removed.

FIG. 12 is a side elevation detail of the belt lift device on the upstream end of the mesh belt section of the double backer.

### DETAILED DESCRIPTION OF THE INVENTION

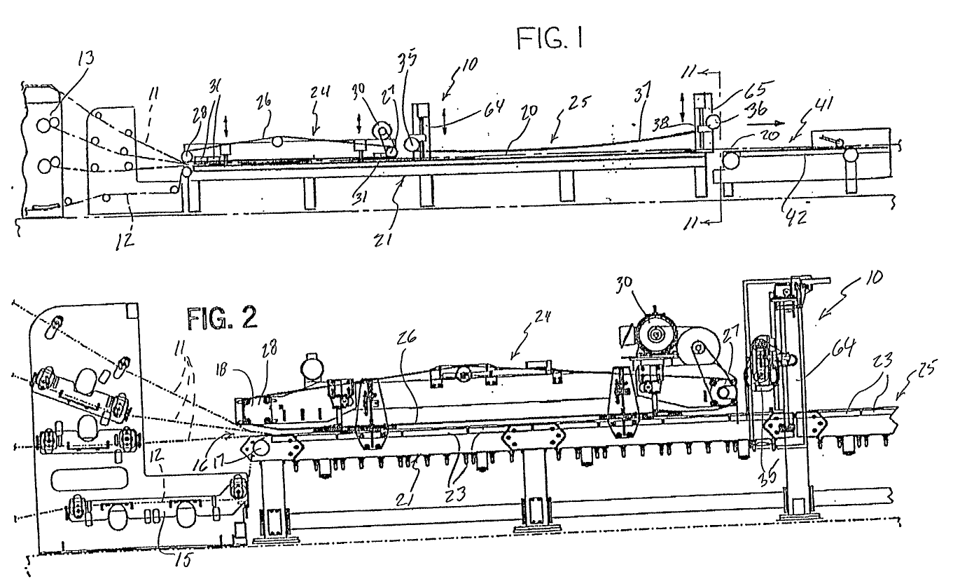

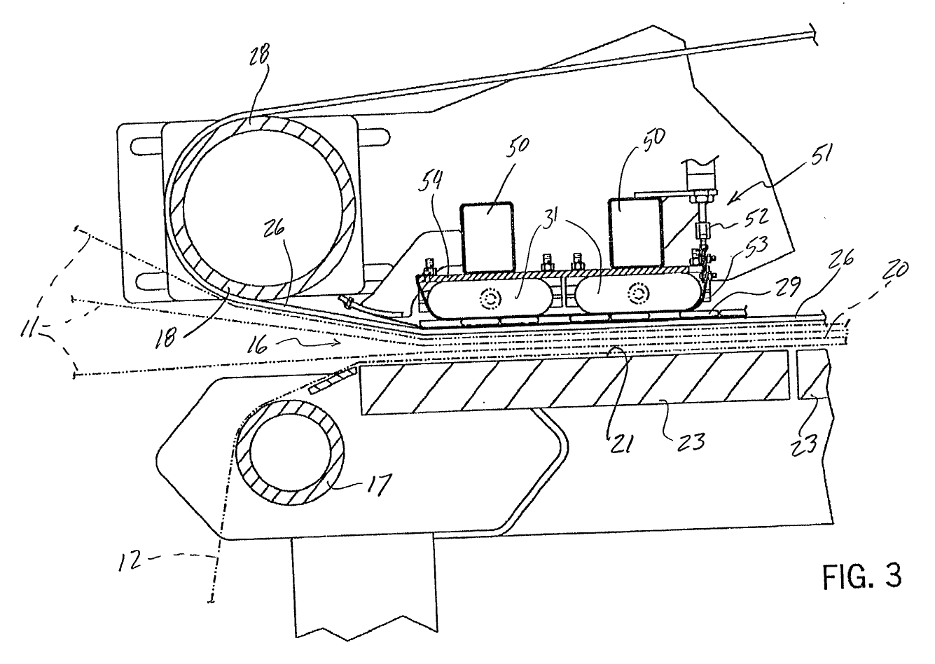

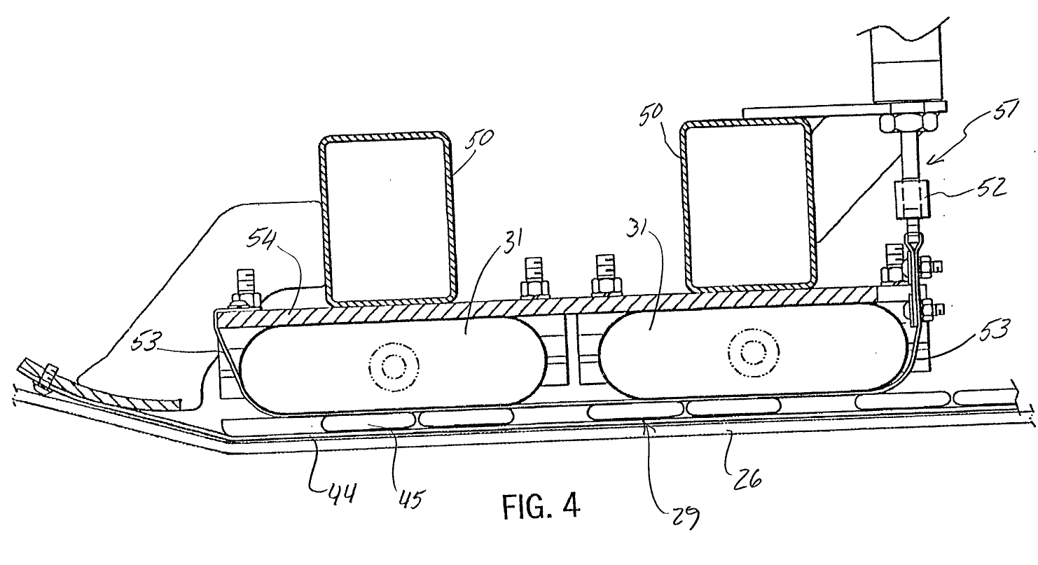

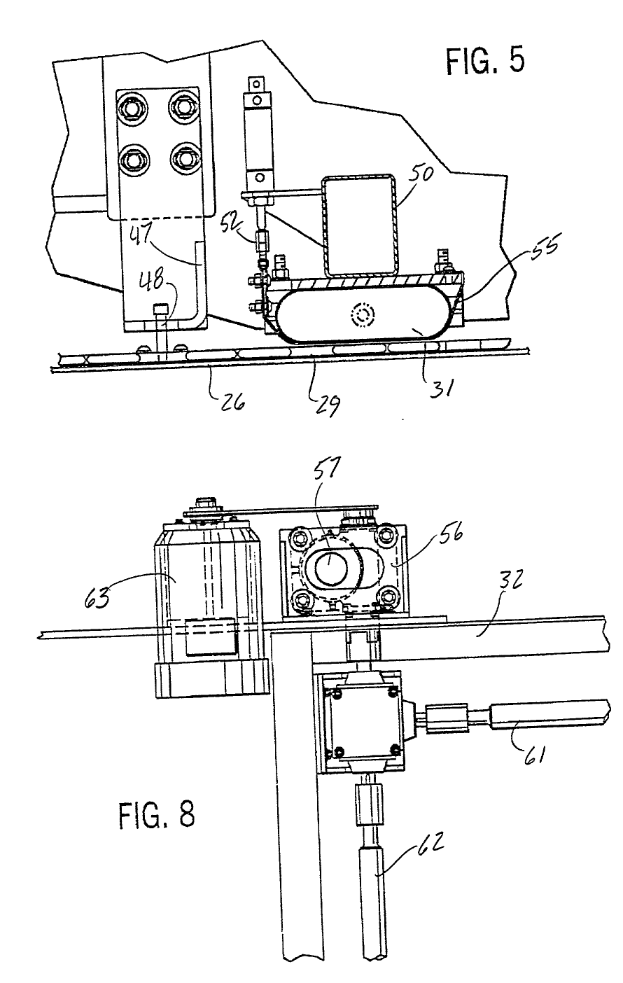

Referring initially to FIGS. 1 and 2, a double backer 10 receives one or more single face webs 11 to the flute tips of which a starch-based adhesive has been applied by a glue machine 13 and joins the glued single face web to a liner web 12 delivered from beneath the single face web 11. The liner face of the single face web 11 passes over a web preheater prior to entry into the double backer. Similarly, the liner web 12 also passes over a liner preheater station 15 before being joined with the single face web 11 (or multiple webs if running multi-wall board) at a double backer infeed 16 at the upstream end of the double backer 10. To facilitate joinder of the component webs, the infeed 16 includes a lower liner infeed roll 17 and an upper single face infeed roll 18 that form a low pressure nip to initially form the freshly glued double face web 20, or, if multiple single face webs are joined, a multi-wall board 19 as shown schematically in FIG. 3.

The double backer 10 includes a lower heating section 21 over which the double face web 20 travels in contact with a generally horizontal heated surface 22. The surface is defined by a series of hot plates 23 mounted in abutting edge-to-edge relation along the full length of the heating section 21. The hot plates 23 are typically constructed of cast iron or steel and are internally heated by steam to a temperature high enough to heat the double face web 20 to a temperature of at least 100° C. Typically, each hot plate 23 extends the full width of the double backer (in the cross machine direction) and thus has a width of about 9 feet (about 2.75 m). In the machine direction (direction of movement of the double face web 20), each hot plate 23 is substantially narrower and may have a length of about 2 feet (about 600 mm). A typical double backer may have a substantially continuous heated surface 22 of about 40 feet (about 12 m) in length, comprising twenty hot plates 23.

To facilitate curing of the starch adhesive and drying of the double face web 20, the web is pressed from the top against the hot plates 23 by the combination of an upstream driven holddown belt section 24 and an immediately adjoining downstream porous belt section 25 that is horizontally stationary but vertically flexible.

The upstream driven holddown belt section 24 includes a continuous impervious belt 26 which may typically be made of a fiber or fabric material, such as woven polyester. The belt is entrained around a driven head pulley 27 and an idler tail pulley 28 which preferably acts with the belt 26 as the single face infeed roll 18. A motor and belt reduction arrangement 30 are mounted at the top of the holddown belt section 24 to drive the head pulley 27 and belt 26. The belt 26 is positioned to operate in direct contact with the double face web 20 and thus acts to press the freshly glued web against the underlying heated surface 22 and assists in moving the web through the double backer. The primary web drive is located downstream from the heating section 21 and will be described in greater detail below. However, it has been found that the drive assistance provided by the driven belt section 24 is particularly important in preventing tear out in the freshly glued double face web which, at this point, is still quite moist and has significantly less strength than after it has cured and dried in the downstream portion of the double backer. The driven holddown belt section 24 is also very useful in initial web thread-up and, in this manner, operates like a prior art double backer.

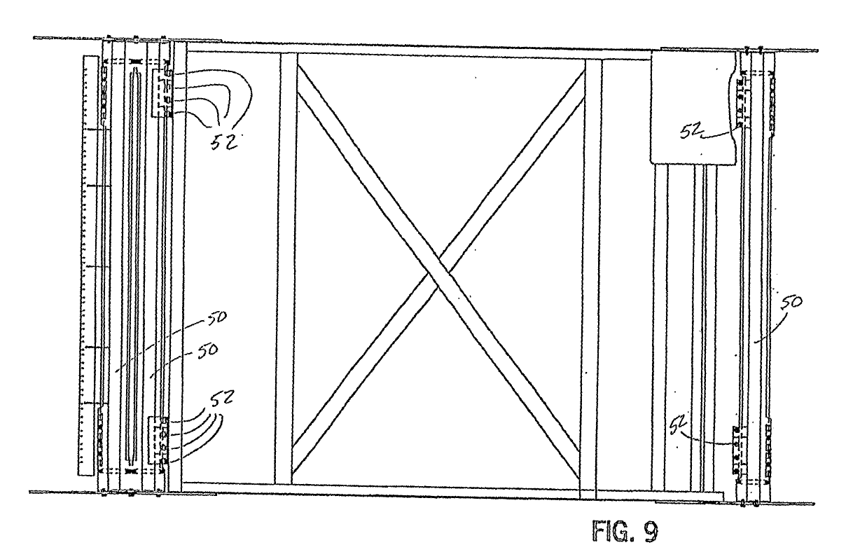

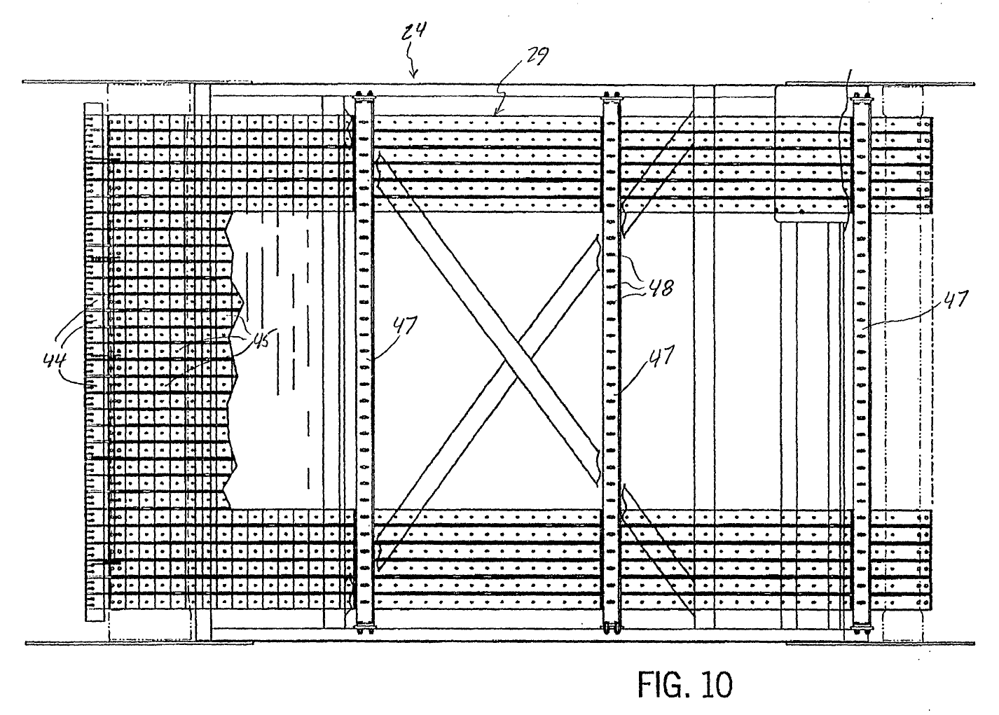

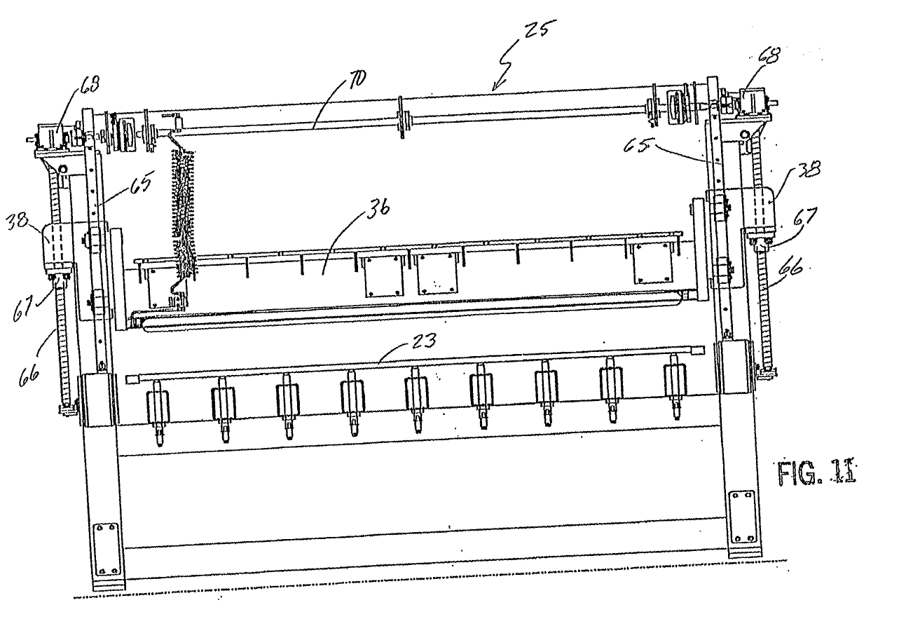

Means are provided to impose a static ballast load on the belt. This supplemental holddown may be provided in a number of ways, including a vertically flexible holddown mat providing a uniform load of about 25 lbs. per square foot (about 1200 Pa). The supplemental holddown load could also be provided by a series of rollers, plates or semi-rigid bars or strips extending in the cross machine direction between the side frame members 32. In the embodiment shown, the supplemental ballast load is provided by an open mesh mat 29 that lies atop the belt 26 between the head and tail pulleys 27 and 28. The mat 29 provides the needed uniform load on the belt 26 and the double face web 20 on which the belt rests. The open mesh ballast mat 29 is preferably of the type shown in U.S. Pat. No. 5,853,527, the disclosure of which is incorporated herein by reference, and includes closely spaced machine direction stainless steel strips 44 joined by weighted cross-tie strips 45, as best seen in FIGS. 4 and 9. The ballast mat is disposed with the machine direction stainless steel strips 44 lying directly atop the board-contacting run of the belt 26. The upstream ends of the steel strips 44 are attached to a common cross machine direction mounting plate 46. The mounting plate 46 is curved upwardly to keep the bolted connections for the strips out of contact with the belt 26 as it travels downwardly around the tail pulley 28 and under the ballast mat 29.

The downstream end of the ballast mat 29 remains unattached and simply lies on the inside surface of the driven belt 26. However, just upstream from the downstream end of the ballast mat 29 and at two additional equally spaced points upstream therefrom, the ballast mat is connected to cross machine direction angle members 47 with bolted connectors 48 that permit limited vertical movement of the ballast mat, but help raise the mat when the entire holddown belt section 24 is lifted from the hot plates 23 as will be described hereinafter.

It has been found to be important to bring the freshly glued double face web 20 between the belt 26 and hot plates 23 as quickly as possible. The water in the starch-based adhesive reaches the boiling point very rapidly and steam is evolved almost immediately in the double backer. In addition and as indicated above, the freshly glued double face (or multiple wall) web 20 is still quite moist and has significantly less strength than after it is fully cured. If the double face web is not captured and held between the belt and the hot plates quite quickly, steam pressure within the flutes of the web may tend to blow out and rupture the web, particularly in relatively weak areas. On the other hand, if the double face web is sandwiched securely and uniformly between the belt and the hot plates, the steam will migrate laterally along the flutes in the cross machine direction and exit from the edges of the board.

In order to help assure rapid and uniform holddown of the double face web 20 as it enters the double backer, air bags 31 are positioned at the upstream and downstream ends of the lower run of the holddown belt 26 and connected to impose a further downward load on the ballast mat 29, the belt 26, and the double face web 20 traveling thereunder. The air bags are positioned as close as practicable to the upstream tail pulley 28 to remove some of the natural catenary curve in the belt and cause it to be pressed into contact with the double face web more closely to the upstream infeed. Correspondingly, the downstream air bag 31 maintains the belt in contact with the double face web for a slightly longer period of time, again by eliminating some of the natural catenary as the belt lifts off the hot plate section to proceed around the head pulley 27. On the upstream end, two closely spaced air bags are utilized which extend in parallel across the entire width of the belt. Each air bag is mounted beneath a cross machine direction box beam 50 having a series of support plates 54 attached to the underside which provide an upper vertical restraint. The lower faces of the air bags lie directly atop the ballast mat 29 such that, when inflated, the bags are pressed downwardly against the mat, underlying belt and double face web. On the downstream end of the belt section 24, a single air bag 31 is mounted beneath a box beam 50, but otherwise operates in the same manner as the pair of upstream air bags.

As indicated above, it is most helpful, particularly in the upstreammost portion of the double backer to permit evolving steam to escape laterally through the open flutes of the corrugated double face web 20. However, if a narrower web is being run than the typical maximum of 96 inches (about 2400 mm), the lateral outer edges of the driven belt 26 will tend to be forced by the air bags 31 against the surfaces of the hot plates 23 where there is no double face web present. This not only causes undue wear to the belt, but it tends to close off the flute ends and inhibit the escape of steam. This, of course, may increase the possibility of blowout and rupture of one of the liner webs, particularly the upper single face liner. To alleviate this potential problem, a bag end lift device 51 is provided on each end of the pair of upstream air bags 31 and on each end of the downstream single air bag. Referring particularly to the upstream lift device 51 shown in FIGS. 3, 4 and 9, four air cylinders 52 are attached to the downstreammost of the two box beams 50 with their rod ends attached to flexible straps 53 encircling the lower face of the air bag and secured to support plates 54 on the opposite side of the upstream most box beam 50. The air cylinders 52 are operated in pairs of two such that, as a narrower web is being processed, the pairs of outermost cylinders 52 are actuated to retract and cause the flexible strips 53 to squeeze and slightly flatten the ends of the air bags 31. As webs that are narrower yet are run, the inside pairs of cylinders 52 on both ends of the air bags are also actuated to relieve direct air bag pressure from the belt 26, particularly when there is no double face web running immediately thereunder. On the downstream end of the driven belt section 24, the bag end lift device 51 is substantially the same, except that only a single air bag 31 is used and the flexible straps 55 are correspondingly shorter.

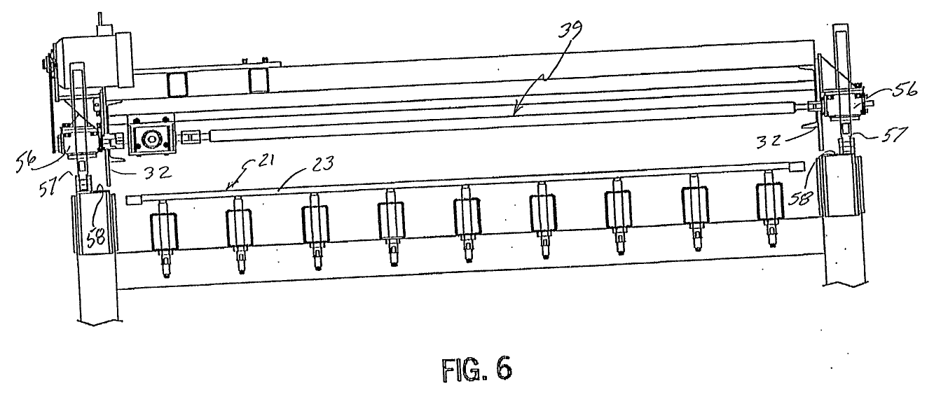

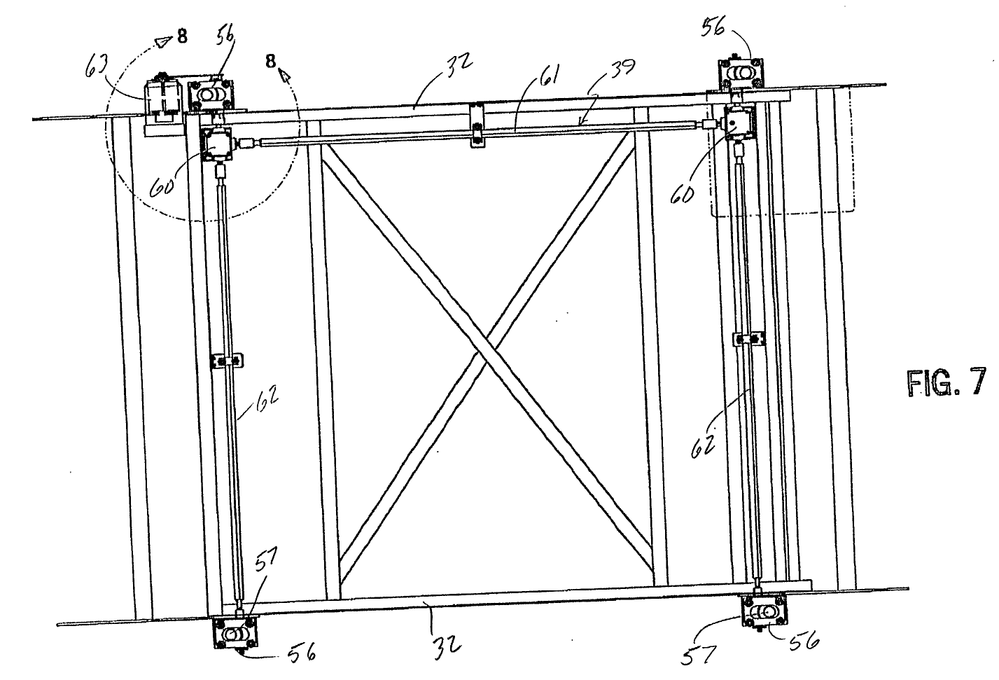

Referring to FIGS. 6-8, it is also desirable to lift the entire holddown belt section 24 vertically to facilitate cleaning and for clearing jams. The entire belt section is supported by a pair of lateral side frame members 32 which support a belt section lift device 39. The lift device 39 comprises four worm screw actuators 56, a pair of which are mounted to the outside face of each side frame member 32. The actuator screws 57 are positioned to bear against a horizontal side flange 58 of the lower heating section 21. The actuators 56 are connected to run in synchronization and, as the screws 57 are driven downwardly, the ends bear on the side flanges 58, causing the entire belt section 24 to lift vertically from the hot plates 23. To maintain the synchronized operation of the screw actuators 56, two of the actuators on one side are connected to right angle gear boxes 60 which are, in turn, tied together with a timing shaft 61 and from each of which a driveshaft 62 extends to the opposite side and into driving engagement with an actuator 56. The entire synchronized arrangement is driven by a single electric motor 63 operatively connected to one of the screw actuators 56.

The driven holddown belt section 24 preferably has a length slightly less than half the length of the heating section 21 and, thus, may extend over approximately the first eight hot plates or about 16 feet (about 5 m).

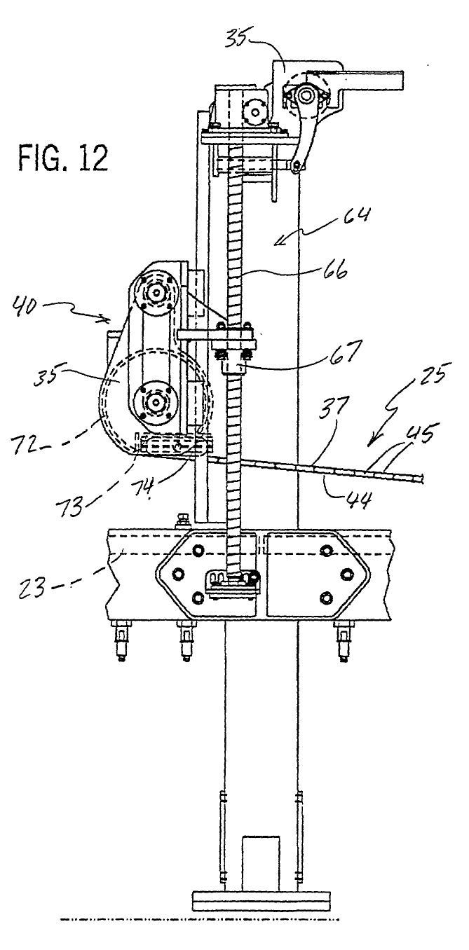

Overlying the remainder of the heating section 21, downstream from the driven belt section 24, the porous mesh belt section 25 extends between upstream and downstream cross supports 35 and 36, respectively. The cross supports, in turn, are mounted between upstream and downstream pairs of vertical supports 64 and 65, respectively. The porous belt section 25 preferably comprises an open mesh belt 37 similar to or the same as ballast mat 29, such as described in U.S. Pat. No. 5,853,527. Thus, closely spaced machine direction flexible stainless steel strips 44 are joined by weighted cross-tie strips 45. The downstream cross support 36 is provided with a lift mechanism 38 permitting the downstream end of the mesh belt 37 to be lifted vertically such that more or less of the total length of the belt is permitted to rest on the double face web 20 traveling over the heated surface of the hot plates 23. As is best seen in FIGS. 11 and 12, the downstream lift mechanism 38 comprises a pair of lead screws 66 attached to the downstream vertical supports 65 and to which are operatively attached respective screw followers 67 mounted on each end of the downstream cross support 36. The upper ends of the lead screws 66 are driven from right angle gear boxes 68 which are interconnected with a timing shaft 70. One of the gear boxes 68 is driven by a motor 71. The porous mat 37 is constructed to provide a uniform holddown load on the double face web. The uniform load may be similar to that provided by ballast mat 29 in the driven belt section 24, but the porous mesh belt 37 may be constructed to provide a higher or lower holddown load, as desired. A uniform load of 13 lbs. per square foot (about 620 Pa) has been found to work well. The upstream cross support 35 is also provided with a lift mechanism 40 so that, for cleaning, thread-up and the like, the porous mesh belt 37 may be lifted completely from contact with the hot plates or a double face web traveling through the heating section 21. The upstream lift mechanism 40 operates in the same manner as the downstream lift mechanism 30 described above. Thus, it includes a pair of lead screws 66 attached to the upstream vertical supports 64 and driven to cause the screw followers 67 attached to the upstream cross support 35 to move vertically and carry the upstream end of the mesh belt 37 with it. The porous mesh belt section 25 is positioned immediately adjacent the upstream driven belt section 24 and, thus, preferably covers approximately the last 12 hot plates 23. In the example described above, the porous belt section 25 would have a length of about 24 feet (about 7 m).

As mentioned above, the upstream driven belt section 24 provides a region of concentrated heating applied immediately to the freshly glued double face web 20 to cause rapid gelatinization and substantial completion of the green bond which occurs by dehydration of the starch-based adhesive. The open construction provided by the mesh belt 37 in the downstream porous belt section 25 permits completion of the green bond cure while allowing moisture to dissipate thereby promoting rapid drying of the entire web 20.

Referring to FIG. 12, the upstream cross support 35 for the porous mesh belt 37 comprises a generally cylindrical drum 72 to which the ends of the machine direction stainless steel strips 44 of the belt 37 are attached. The lower portion of the drum 72 is cut out to provide a full cross machine direction slot 73 within which is mounted an air bag 74 similar to the air bags 36 used on the upstream driven belt section 24. In normal operation, the upstream lift mechanism is operated to lower the upstream cross support 35 to bring the upstream end of porous mesh belt 37 down into direct contact with the double face web 20 that is running over the hot plates 23. Inflation of the air bag 74 helps eliminate some portion of the natural catenary in the mesh belt 37 leading from its connection to the drum 72. It is also desirable to provide the air bag 74 with a bag end lift device to eliminate a portion of the downward load applied by the inflated bag near the lateral edges thereof when running narrower webs. The lift device may be constructed and operated in the same manner as the lift devices 51 utilized on the upstream driven holddown belt section 24.

Immediately downstream from the heating section 21 is a main driven traction section 41 providing the main drive for pulling the double face web 20 through the heating section. In the embodiment shown in FIG. 1 of the drawings, the traction section 41 comprises a vacuum conveyor 42. However, other types of belt drives well known in the industry, such as a pair of driven sandwich belts, could be used. One type of suitable vacuum conveyor web drive is shown in U.S. Pat. No. 5,706,994, the disclosure of which is incorporated herein by reference.

In operation, beginning with machine startup, freshly glued double face web 20 can be threaded into the double backer by the machine operator in the same manner as a conventional prior art double backer. By the time the single face web leaves the driven belt section 24, the starch adhesive will have reached a significant green bond strength level such that the web is rigid enough to allow it to be pushed over the remaining portion of the heating section 21 until the lead end is engaged by the main vacuum traction conveyor 42. The porous mesh belt section 25 may then be lowered into contact with the web for full operation. As with conventional double backers, hot plate temperatures may be individually controlled or controlled in a number of zones along the heating section 21. The driven holddown belt section 24 aids in driving the web, but is primarily used to reduce friction and enhance initial cure. The system has been found to work well in handling lighter weight double face webs and at line speeds well in excess of 1000 fpm (300 m per minute). For normal operation, the upstream driven holddown belt 26 is operated in a torque limited mode with respect to the main traction section 41. The belt 26 is driven at or slightly greater than the speed of the main traction section 41 such that the belt 26 will assist in moving the web, but will not be driven with enough torque to move the web independently of main vacuum traction conveyor 42.

I claim:

1. A double backer apparatus for the production of a double face corrugated paperboard web from a liner web joined to a single face web with an aqueous starch based adhesive, said apparatus comprising:
a plurality of hot plates defining a generally horizontal substantially continuous heated surface to support and heat a freshly glued web moving over the heated surface, said heated surface having an upstream infeed end and a downstream outfeed end;
a driven holddown belt section overlying a portion of the heated surface from the upstream end to press the freshly glued web against the heated surface and to assist in moving the web thereover;
a horizontally stationary vertically flexible porous belt section overlying the web along the remaining portion of the heated surface from the downstream end of the driven belt section to the outfeed end to maintain the web against the heated surface and to permit the escape of moisture from the web, said porous belt section having a lift device on the downstream end to selectively vary the length of the flexible belt section in contact with the web; and,
a main driven traction section immediately downstream from the outfeed end to engage the web and pull the web over the heated surface.

2. The apparatus as set forth in claim 1 wherein the driven holddown belt section extends over less than one-half the length of the continuous heated surface.

3. The apparatus as set forth in claim 1 wherein the driven holddown belt section has a width in the cross machine direction approximately equal to the width of the hot plates.

4. The apparatus as set forth in claim 1 wherein the driven holddown belt section comprises:
a continuous generally impervious flexible belt entrained around horizontally spaced upstream and downstream pulleys to present a lower web-engaging belt face to the web moving over the heated surface;
a belt pressure device overlying a portion of the driven holddown belt adjacent the upstream end to apply a supplemental holddown load to the belt.

5. The apparatus as claimed in claim 4 wherein the belt pressure device comprises an inflatable air bag.

6. The apparatus as set forth in claim 4 wherein the belt pressure device comprises a ballast mat overlying the holddown belt.

7. The apparatus as set forth in claim 6 wherein the ballast mat extends between said upstream and downstream pulleys.

8. The apparatus as set forth in claim 7 comprising an upstream air bag operation to press the ballast mat against the flexible belt immediately adjacent the upstream pulley.

9. The apparatus as set forth in claim 8 comprising an upstream air bag operation to press the ballast mat against the flexible belt immediately adjacent the upstream pulley.

10. The apparatus as set forth in claim 9 including a bag end lift device operable to reduce the load applied to the ballast mat along lateral outer ends of the air bags.

11. The apparatus as set forth in claim 1 comprising a frame supporting the driven holddown belt section above the heating section, and a belt lift device operatively connected to the frame to lift the driven belt section vertically from the heated surface.

12. The apparatus as set forth in claim 1 wherein the porous belt section extends over more than one-half the length of the continuous heated surface.

13. The apparatus as set forth in claim 1 wherein the porous belt section has a width in the cross machine direction approximately equal to the width of the hot plates.

14. The apparatus as set forth in claim 1 wherein the porous belt section comprises a flexible mesh belt including a series of generally parallel holddown strips extending over the web in the direction of web travel between upstream and downstream mat end supports.

15. The apparatus as set forth in claim 14 wherein said mesh belt includes a series of generally parallel flexible tie strips extending generally perpendicular to, overlying and interconnecting said holddown strips.

16. The apparatus as set forth in claim 14 wherein said mesh belt is arranged to apply a uniformly distributed load to the double face web.

17. The apparatus as set forth in claim 1 wherein the lift device comprises a downstream cross support movable in a generally vertical direction.

18. The apparatus as set forth in claim 17 including an upstream lift device comprising an upstream cross support operable with the downstream cross support to lift the entire porous belt section vertically from the web.

19. A method for bonding and drying a single face corrugated paperboard web freshly glued with a starch adhesive, comprising the steps of:
(1) moving the freshly glued web over a heated surface between an upstream web infeed end and a downstream web outfeed end;
(2) forming a green bond in the adhesive by applying a combined holddown load and traction force to the web with a driven holddown belt section overlying the web along an upstream portion of the heated surface;
(3) drying the web by pressing the web against a remaining portion of the heated surface downstream from the holddown belt section with a flexible porous belt section; and,
(4) pulling the web over the heated surface with a main driven traction section downstream from the outfeed end.

20. The method as set forth in claim 19 wherein said drying step includes applying a variable downward load on the holddown belt section and the web moving thereunder.

21. The method as set forth in claim 19 wherein said drying step includes adjusting the vertical distance of the downstream end of the porous belt section from the web to selectively vary the length of said porous belt section in contact with the web.
